(19) United States
(12) Patent Application Publication
(10) Pub. No.: US 2026/0258247 A1
(43) Pub. Date: Sep. 3, 2026

(54) PRODUCTION OF POLYURETHANE FOAM

(71) Applicant: EVONIK OPERATIONS GMBH, Essen (DE)

(72) Inventors: Martin GLOS, Borken (DE); Jobst GRIMMINGER, Ellerau (DE); Michael FERENZ, Essen (DE); Torsten METZ, Gelsenkirchen (DE)

(73) Assignee: EVONIK OPERATIONS GMBH, Essen (DE)

(21) Appl. No.: 18/865,820

(22) PCT Filed: May 4, 2023
(86) PCT No.: PCT/EP2023/061799

§ 371 Date: Nov. 14, 2024

(30) Foreign Application Priority Data
May 17, 2022 (EP) 22173671.3

(51) Int. Cl. C08L 75/06; C08G 18/08; C08G 18/18; C08G 18/22; C08J 9/08; C08J 9/14; C08K 5/01; C08K 5/521

(52) U.S. Cl. CPC C08L 75/06; C08G 18/14; C08G 18/18; C08G 18/225; C08J 9/08; C08J 9/141; C08K 5/01; C08K 5/521; C08G 2110/0025; C08G 2110/005; C08G 2110/0058; C08G 2330/00; C08J 2201/022; C08J 2203/02; C08J 2203/14; C08J 2203/204; C08J 2375/06; C08J 2483/04; C08L 2201/02

(57) ABSTRACT

What are described are (a) a composition suitable for production of polyurethane foam, comprising at least one polyisocyanate component, a polyol component, optionally a catalyst that catalyses the formation of a urethane or isocyanurate bond, optionally blowing agents, where the composition additionally comprises hydrocarbons HC, Si-free surfactant and optional polyalkylsiloxane, (b) a process for producing polyurethane foam using hydrocarbons HC, Si-free surfactant and optional polyalkylsiloxanes, (c) the polyurethane foam thus obtainable and (d) the use thereof.

The present invention is in the field of polyurethane foams. More particularly, it relates to the production of polyurethane foams using specific hydrocarbons and Si-free surfactant, and additionally to the use of the foams which have been produced therewith.

Polyurethane (PU) in the context of the present invention is in particular understood to mean a product obtainable through reaction of polyisocyanates and polyols or compounds having isocyanate-reactive groups. In addition to the polyurethane, further functional groups may also be formed in the reaction, for example uretdiones, carbodiimides, isocyanurates, allophanates, biurets, ureas and/or uretonimines. For the purposes of the present invention, PU is therefore understood to mean not just polyurethane, but also polyisocyanurate, polyureas, and polyisocyanate reaction products containing uretdione, carbodiimide, allophanate, biuret and uretonimine groups. In the context of the present invention, polyurethane foam (PU foam) is especially understood to mean foam which is obtained as reaction product based on polyisocyanates and polyols or compounds having isocyanate-reactive groups. In addition to the eponymous polyurethane, further functional groups can be formed as well, examples being allophanates, biurets, ureas, carbodiimides, uretdiones, isocyanurates or uretonimines.

Polyurethane and polyisocyanurate foams are usually produced using cell-stabilizing additives to ensure a fine-celled, uniform and low-defect foam structure and hence to exert an essentially positive influence on the performance characteristics, particularly the thermal insulation capacity, of the foam. Usually, polyethersiloxane foam stabilizers (PESs) are used here, especially for rigid foam applications. These Si-containing surfactants are the preferred choice here. They therefore generally represent the preferred type of foam stabilizers. However, the use of Si-free surfactants is also described in numerous documents.

EP 2511328 B1 describes the use of carbamates as surfactant for foam stabilization.

DE 1020011007479 A1 describes mixtures of acid amides with PESs for use as foam stabilizers in rigid PU foam.

EP 1985642 uses amido amines and imidazoles based on carboxylic acids and polyethylene- or polypropyleneamines, such as for example diethylenetriamine, triethylenetetramine or tetraethylenepentamine, as additives for the production of PU foams.

U.S. Pat. No. 3,746,663 describes the use of N-vinylpyrrolidone-based structures for use as surfactant in PU foam production.

DE 3724716 C1 describes the use of novolak-based ethoxylates as stabilizers in PU foam production.

EP 0734404 describes the production of PU foams using polyalkylene oxides, where the polyalkylene oxides are formed using 10-90% butylene oxide.

EP 1985642 describes a composition for production of PU foam using amide amines and/or imidazoles based on C1-C36 carboxylic acids.

U.S. Pat. No. 5,236,961 describes the production of polyurethane foams using alkylphenol ethoxylates as foam stabilizers.

DE 2244350 A1 describes the use of copolymers produced from N-vinylpyrrolidone and maleic esters for the production of polyurethane foam.

The use of Si-free surfactants in PU foams is therefore sufficiently well known. Nevertheless, however, a person skilled in the art hitherto assumed that Si-free surfactants lead to reduced foam qualities compared to Si-containing surfactants, in particular compared to the polyether-modified siloxanes (PESs). Particularly when the PU foams are intended to achieve a good insulation performance, that is to say a low lambda value, Si-containing surfactants, i.e. in particular the polyether-modified siloxanes (PESs), are often advantageous compared to Si-free surfactants.

However, the use of Si-containing surfactants, in particular of polyether-modified siloxanes (PESs), can also have disadvantages. For instance, they can impair the solubility of the blowing agents (e.g. pentanes) in the polyols. This is particularly pronounced when the PESs have a high siloxane proportion and are therefore highly hydrophobic. In addition, the Si-containing surfactants are not based on renewable raw materials and are thus disadvantageous for sustainability reasons.

There was therefore the desire to provide PU foams having high foam quality or good insulation performance without the use of Si-containing surfactants being necessary for this purpose.

Besides the use of Si-free surfactants in PU foams, the use of hydrocarbons in PU foams is also sufficiently well known. For instance, hydrocarbons are often used in PU foams as blowing agent. Preference is given here to using compounds having at most 7, in particular 3 to 7 carbons, since these have their boiling points within the appropriate temperature range, such that they evaporate in the foaming process and hence contribute to an increase in volume, i.e. to formation of foam. In the finished foam, these blowing agents are then still present in the foam as cell gas. The use of these hydrocarbons is described in numerous documents.

US 20110218259 describes the use of cyclopentane in rigid PU foam systems having improved flowability, as required, for example, in the production of cooling units or panels.

EP 421269 describes the use of cyclopentane and mixtures thereof with cyclohexane and various hydrocarbons having max. 4 carbons, and ethers and fluoroalkanes having a boiling point of less than 35° C. What are used here are thus hydrocarbons that all evaporate in the course of PU foaming and hence serve as blowing agents.

WO 2016202912 describes various hydrocarbons and also ethers, ketones, esters, acetals and fluoroalkanes as blowing agents. The boiling points are preferably below 50° C.

CN 101880452 describes the use of alkanes having 14 to 21 carbons as phase transition material which is used as filler in amounts of 10 to 30 parts per 100 parts polyol. There is no description here of any effects on the quality of a PU foam produced therewith with regard to its thermal conductivity.

JP 09165427 describes the use of alkanes having 9 to 12 carbons, which serve to improve the storage stability of the polyol mixture, specifically when pentane is used as blowing agent. 1 to 10 parts of the alkanes are used based on 100 parts polyol. There is no description here of any effects on the quality of a PU foam produced therewith with regard to its thermal conductivity.

US 20070066697 describes flexible PU foams of improved compression hardness through use of hydrocarbons having 10 to 70 carbons. The dosage is from 0.01 to 100 pphp, 1 to 25 pphp, 2 to 8 pphp (pphp=parts per hundred polyol=parts per hundred parts of polyol).

JP 04018431 describes the use of unreactive components, for example paraffins or other hydrocarbons, that are added in amounts of 0.1 to 10 pphp, in rigid PU foam, which is said to improve the ageing of the foam with regard to the lambda value. The examples here show that the initial lambda values worsen on addition of paraffin.

EP 3677610 describes the use of specific hydrocarbons in combination with polyether-modified siloxanes as surfactants for obtaining rigid PU foams having improved properties. This combination is disclosed as obligatory. No possibility is described for achieving improved properties of rigid PU foams without polyether-modified siloxanes as well.

None of the aforementioned documents discloses the combined use of certain hydrocarbons (HC) that have boiling points at standard pressure of >100° C. and Si-free surfactants (SifS).

The problem addressed by the present invention was that of overcoming at least one disadvantage of the prior art. The problem addressed in particular was that of providing polyurethane or polyisocyanurate foams that have particularly advantageous properties, such as in particular a low thermal conductivity (good insulation performance) and/or high foam quality, in particular good surface quality, without having to use Si-containing surfactants in the process.

Surprisingly, it has now been found that the use of Si-free surfactants does not lead to reduced foam qualities when they are combined with specific hydrocarbons HC that have boiling points at standard pressure of >100° C. In particular, as a result of the use of specific hydrocarbons HC, PU foams having improved lambda values can be produced without having to use Si-containing surfactants such as for example polyether-modified siloxanes.

The problem is thus solved by the combined use of certain hydrocarbons HC that have boiling points at standard pressure of >100° C. and Si-free surfactants (SifS).

As a result of the combination of certain hydrocarbons HC that have boiling points at standard pressure of >100° C. and Si-free surfactants, PU foams having improved performance characteristics (such as in particular lambda values) can be produced. More particularly, low thermal conductivity and/or good surface quality are enabled. A good fine-cell content is also achieved. Foam defects can be reduced.

By the present invention, it is thus possible to produce PU foam-based products, for example insulation panels or cooling units, with higher quality or to make the processes for production more efficient. Even a very small addition of hydrocarbons HC of the invention, in interplay with Si-free surfactants (SifS), enables corresponding improvements.

The invention thus firstly provides a composition for production of polyurethane foam, comprising at least one polyisocyanate component, a polyol component, optionally a catalyst that catalyses the formation of a urethane or isocyanurate bond, optionally blowing agents, where the composition additionally comprises hydrocarbons HC that have boiling points at standard pressure (1.01325 bar) of >100° C., preferably >150° C., and Si-free surfactant.

The invention further provides a process for producing polyurethane foam by reacting one or more polyol components with one or more polyisocyanate components, characterized in that the reaction is effected in the presence of hydrocarbons HC, Si-free surfactant and optionally polyalkylsiloxanes, especially using the composition according to the invention.

The invention yet further provides for the use of a combination of hydrocarbons HC, Si-free surfactant and optional polyalkylsiloxanes for production of polyurethane foams, preferably as foam stabilizer, more preferably for improvement of the insulation properties of the polyurethane foam, especially using the composition according to the invention.

The invention yet further provides a polyurethane foam obtainable by the process according to the invention.

According to a preferred embodiment, the polyurethane foam obtainable according to the invention has lambda values (in mW/m-K) of less than 24, preferably less than 23, in particular less than 22.

The thermal conductivity coefficient, that is the lambda value, (A value in mW/m-K) can in the context of the present invention preferably be determined in accordance with the provisions of the standard EN 12667:2001-05, in particular as specified in the experimental section.

The invention yet further provides for the use of the polyurethane foam according to the invention as insulation boards and/or insulant, preferably for cooling apparatuses.

Advantageous configurations of the subject-matter of the invention can be gathered from the claims, the examples and the description. Furthermore, it is explicitly pointed out that the disclosure relating to the subject-matter of the present invention includes all combinations of individual features of the present or subsequent description of the invention and of the claims. More particularly, embodiments of one subject of the invention are also applicable mutatis mutandis to the embodiments of the other subjects of the invention.

The hydrocarbons HC according to the invention have boiling points at standard pressure (1.01325 bar) of above 100° C., preferably above 150° C. Preference is given here for the boiling points at standard pressure to be below 400° C., preferably below 350° C. The hydrocarbons HC thus preferably have boiling points at standard pressure of >100° C. to <400° C., in particular of >100° C. to <350° C. The hydrocarbons HC consist of carbon atoms, hydrogen atoms and optionally at most 3 heteroatoms selected from the group consisting of oxygen, nitrogen and sulfur atoms. Preferably, the hydrocarbons HC, if they do contain heteroatoms, comprise only oxygen atoms as heteroatoms. It is preferable for the hydrocarbons HC to have one heteroatom or no heteroatoms, where the heteroatom, when they have one, is an oxygen atom. However, it is yet more preferable for the hydrocarbons HC not to have any heteroatoms. It is thus particularly preferable for the hydrocarbons HC to consist exclusively of carbon atoms and hydrogen atoms. It is possible to use either saturated or else unsaturated hydrocarbons HC. It is possible to use aliphatic or aromatic hydrocarbons HC. The hydrocarbons HC may be branched or unbranched. They may be cyclic or acyclic hydrocarbons HC.

Preferred hydrocarbons HC are olefins, paraffins, isoparaffins or alkylbenzenes, in a preferred embodiment of the invention. Such materials are available, for example, from Sasol under the following trade names: HF-1000, LINPAR, SASOLAB, PARAFOL.

The hydrocarbons HC of the invention are preferably hydrocarbons (branched or unbranched, saturated or unsaturated, cyclic or acyclic, aliphatic or aromatic) having 10 to 24 carbon atoms. These may for example be prepared by oligomerization of olefins as described in U.S. Pat. No. 4,647,707, DE102008007081A1 and DE102013212481A1.

It is likewise also possible to use corresponding streams of matter that are obtained in the preparation of oxo alcohols, as described in U.S. Pat. No. 4,647,707, EP1515934B1 and EP2947064A1. Arising here are intermediates or byproducts known as oxo oils. Preference is given here to paraffin- and olefin-containing distillation fractions such as for example what is known as the light oxo fraction, as described in U.S. Pat. No. 4,647,707.

The hydrocarbons HC according to the invention are very particularly preferably selected from the group consisting of decene, dodecene, dodecane, isododecane, tetradecane, tributene, tributane, tetrabutene, tetrabutane, alkylbenzenes having at least 10 carbon atoms and oxo oils.

It is likewise possible to use hydrocarbons that have been prepared from renewable raw materials such as for example isododecane from Global Bioenergies, produced by the process described in WO 2021/228824.

Particularly suitable hydrocarbons HC are described in EP 3677610 B1, in particular in paragraph [0112].

According to the invention, the hydrocarbons are used in combination with Si-free surfactants (SifS). The designation “Si-free” here means that the surfactants do not contain any silicon atoms. The Si-free surfactants are preferably compounds consisting of carbon atoms, hydrogen atoms and heteroatoms selected from oxygen atoms and nitrogen atoms. Surfactants are also referred to as surface-active agents. In the context of the present inventions, the designation “surfactants” is intended to mean those substances that when added lower the surface tension of water. It is preferable here for the Si-free surfactant, at a concentration of 0.5% by weight in water (i.e. 0.5 parts by weight of Si-free surfactants per 99.5 parts by weight of water), to lower the static surface tension of this surfactant-water mixture at a temperature of 20° C. and preferably at standard pressure (1.01325 bar) to less than 70 mN/m, preferably to less than 60 mN/m, more preferably to less than 60 mN/m, more preferably still to less than 50 mN/m, particularly preferably to less than 40 mN/m. It is therefore preferable for a mixture of 5 parts of the Si-free surfactant in 995 parts of water, at a temperature of 20° C. and preferably at standard pressure (1.01325 bar), to have a static surface tension of less than 70 mN/m, preferably less than 60 mN/m, more preferably less than 60 mN/m, more preferably still less than 50 mN/m, particularly preferably less than 40 mN/m. The static surface tension is preferably determined here to DIN EN 14370:2004-11 (Grenzflächenaktive Stoffe—Bestimmung der Oberflächenspannung [Surface active substances—Determination of surface tension]; German version EN 14370:2004).

Preference is given to conducting the determination in accordance with DIN EN 14370:2004-11 in the following manner:

The surfactants are measured in bidistilled water. The surfactant-water mixtures are calculated here to 100 ml and weighed out on an analytical balance. If foam forms on the sample, it is removed by suction with a pipette. For the measurements, K100MK2 tensiometer from Kruss is used, along with a Krüss Standard plate (Pt, 19.900×0.200×10.000 mm) for the plate method or a Kruss standard ring (du Noüy) (Pt, r=9.545 mm, thickness 0.370 mm) for the ring method, with preference being given to the ring method. For the calibration, type I bidistilled water (resistivity value: 18.2 MΩcm, TOC content <5 ppb, TOC=total organic carbon) from Millipore Simplicity UV from Millipore and 1-octanol 99% from Sigma-Aldrich are used.

The Si-free surfactants can be selected from the group consisting of nonionic surfactants, anionic surfactants, cationic surfactants and amphoteric surfactants (zwitterionic surfactants).

In general, any Si-free surfactants may be used. Preferably used are those Si-free surfactants that are known to be suitable for application in the production of PU foams, in particular rigid PU foams.

It may also be preferable here to use substances that are based on renewable raw materials. For example, EP2295485 A1 describes the use of lecithin as surfactant for the production of rigid PU foam, which may also be used here as Si-free surfactant (SifS).

The Si-free surfactants are preferably selected from the group of nonionic surfactants. By way of example, the following nonionic surfactants may be used:

A preferred class of Si-free surfactants is based on carboxylic acids, which constitute the hydrophobic portion of the surfactant. In this case, the Si-free surfactants are thus carboxylic acid derivatives. The carboxylic acids may be derivatized, i.e. chemically bonded, in various ways here, for example as ester, amide, imide, imidazoline, oxazoline, etc. depending on the species with which the carboxylic acids or carboxylic acid derivatives were reacted to produce the Si-free surfactant.

It is thus preferable for the Si-free surfactant to be a carboxylic acid derivative selected from the group consisting of esters, amides, imides, imidazolines and oxazolines.

Examples of carboxylic acids that can be used include monocarboxylic acids, dicarboxylic acids, tricarboxylic acids, tetracarboxylic acids, based on aliphatic or aromatic hydrocarbons or derivatives thereof.

It is preferable for the carboxylic acids here to have 6 to 40 carbon atoms, in particular 8 to 22 carbon atoms.

The carboxylic acids may for example be saturated or unsaturated, cyclic or acyclic, linear or branched, aromatic or aliphatic. The carboxylic acids may for example also bear one or more double bonds and/or OH functions.

It is also preferable for the Si-free surfactants to be carboxylic acid derivatives of carboxylic acids having 6 to 40, in particular 8 to 22 carbon atoms, where the carboxylic acid derivatives are selected from the group consisting of esters, amides, imides, imidazolines and oxazolines. These carboxylic acid derivatives comprise, as structural element, the carbon backbone of the parent carboxylic acid. Heteroatoms selected from oxygen atoms and nitrogen atoms occur in the carboxylic acid derivatives in place of the oxygen atoms of the carboxyl group of the parent carboxylic acid.

It is preferable for the carboxylic acids to be selected from the group consisting of caproic acid (hexanoic acid), caprylic acid (octanoic acid), capric acid (decanoic acid), lauric acid (dodecanoic acid), myristic acid (tetradecanoic acid), palmitic acid (hexadecanoic acid), stearic acid (octadecanoic acid), arachidic acid (eicosanoic acid), behenic acid (docosanoic acid), lignoceric acid (tetracosanoic acid), palmitoleic acid ((Z)-9-hexadecenoic acid), oleic acid ((Z)-9-hexadecenoic acid), elaidic acid ((E)-9-octadecenoic acid), cis-vaccenic acid ((Z)-11-octadecenoic acid), linoleic acid ((9Z,12Z)-9,12-octadecadienoic acid), alpha-linolenic acid ((9Z,12Z,15Z)-9,12,15-octadecatrienoic acid), gamma-linolenic acid ((6Z,9Z,12Z)-6,9,12-octadecatrienoic acid), di-homo-gamma-linolenic acid ((8Z,11Z,14Z)-8,11,14-eicosatrienoic acid), arachidonic acid ((5Z,8Z,11Z,14Z)-5,8,11,14-eicosatetraenoic acid), erucic acid ((Z)-13-docosenoic acid), nervonic acid ((Z)-15-tetracosenoic acid), ricinoleic acid, hydroxystearic acid and undecenylic acid, and also mixtures thereof, for example rapeseed oil acid, soya fatty acid, sunflower fatty acid, peanut fatty acid and tall oil fatty acid. It is further possible to use dimeric and oligomeric fatty acids as formed in the oligomerization of unsaturated fatty acids.

Sources of suitable fatty acids or fatty acid esters, in particular glycerides, can be vegetable or animal fats, oils or waxes. For example, it is possible to use: pork lard, beef tallow, goose fat, duck fat, chicken fat, horse fat, whale oil, fish oil, palm oil, olive oil, avocado oil, seed kernel oils, coconut oil, palm kernel oil, cocoa butter, cottonseed oil, pumpkinseed oil, maize kernel oil, sunflower oil, wheatgerm oil, grapeseed oil, sesame oil, linseed oil, soybean oil, peanut oil, lupin oil, rapeseed oil, mustard oil, castor oil, jatropha oil, walnut oil, jojoba oil, lecithin, for example based on soya, rapeseed or sunflowers, bone oil, neatsfoot oil, lanolin, emu oil, deer tallow, marmot oil, mink oil, borage oil, safflower oil, hemp oil, pumpkin oil, evening primrose oil, tall oil, and also carnauba wax, beeswax, candelilla wax, ouricury wax, sugarcane wax, retamo wax, caranday wax, raffia wax, esparto wax, alfalfa wax, bamboo wax, hemp wax, Douglas fir wax, cork wax, sisal wax, flax wax, cotton wax, dammar wax, tea wax, coffee wax, rice wax, oleander wax and/or wool wax.

A preferred selection of Si-free surfactants is based on the abovementioned carboxylic acids, which are converted via various chemical reactions to esters, amides, imides, imidazolines, oxazolines or other structures.

Preferred carboxylic acid-based Si-free surfactants are listed hereinafter:

In a preferred embodiment, the Si-free surfactants are carboxylic esters of polyethers, preferably selected from the group consisting of PEG-400 dicocoate, PEG-500 monomethyl ether cocoate, PEG-500 monomethyl ether laurate, PEG-8 ricinoleate, PEG-7 glyceryl cocoate, PEG-30 glyceryl cocoate, PEG 30 glyceryl stearate, PEG-80 glyceryl cocoate, dipropylene glycol dibenzoate, PEG-55 propylene glycol oleate, PEG-18 glyceryl oleate, PEG-150 distearate, glycol distearate, PEG-40 stearate and sucrose stearate.

In a further preferred embodiment, the Si-free surfactants are carboxylic esters of glycerol or polyglycerol, preferably selected from the group consisting of glyceryl stearate, glyceryl oleate, polyglyceryl-4 diisostearate, polyglyceryl-4 isostearate, polyglyceryl-3 oleate, polyglycerol oleic acid ester; polyglycerol fatty acid partial ester, diisostearoyl polyglyceryl-3 dimer dilinoleate, polyglyceryl-4 laurate and polyglyceryl-3 caprylate.

In a further preferred embodiment, the Si-free surfactants are alkoxylated or nonalkoxylated carboxylic esters of sorbitan, preferably selected from the group consisting of sorbitan laurate, polysorbate 20, polysorbate 80, sorbitan oleate, sorbitan stearate and sorbitan trioleate.

Sorbitan esters have long been known as emulsifiers. Sorbitol is a reduced polyol form of glucose and is also known under the name glucitol. Sorbitol can self-condense with elimination of water, thus forming what is known as sorbitan. Sorbitan is generally understood to mean a product mixture of the self-condensation products of sorbitol; these are essentially five- and six-membered, mono- and bicyclic, hydroxy-functional ethers of polyol character. Sorbitan carboxylates are the carboxylic esters of sorbitan and therefore the acylation products of the product mixture described above, where the product mixture has generally been acylated with 1 to 3 mol of carboxylic acids per 1 mol of the products; however, substoichiometric acylations are also conceivable in which the product mixture is acylated with less than 1 mol of carboxylic acid.

In a further preferred embodiment, the Si-free surfactants are carboxamides. Amides can be prepared on the basis of a very wide variety of amines and the abovementioned carboxylic acids.

Suitable for example are amines having at least one primary or secondary amine function for amidation and which may optionally contain one or more hydroxyl groups. Suitable amines thus include for example: ethylenediamine, diethylenetriamine (DETA), triethylenetetramine (TETA), tetraethylenepentamine (TEPA), dipropylenetriamine, tripropylenetetramine, tetrapropylenepentamine, pentapropylenehexamine, hexapropyleneheptamine, and also higher homologues based on ethylenediamine or propylenediamine, 1,2-propylenediamine, 4,4′-diaminodicyclohexylmethane, 3,3′-dimethyl-4,4′-diaminodicyclohexylmethane, 4,4-methylenediphenylenediamine, isophoronediamine, trimethylhexylmethylenediamine, neopentanediamine, octamethylenediamine, polyetheramines such as Polyetheramine D 2000 (BASF), Polyetheramine D 230 (BASF), Polyetheramine T 403 (BASF), Polyetheramine T 5000 (BASF) or else corresponding Jeffamine types from Huntsman, piperazine, aminoethylpiperazine, bis(aminoethyl)piperazine, 1,3-diaminopropane, 3-(cyclohexylamino)propylamine, 3-(methylamino)propylamine, N,N-bis(3-aminopropyl)methylamine, (3-(2-aminoethylamino)propylamine), dipropylenetriamine, N,N′-bis(3-aminopropyl)ethylenediamine.

Suitable hydroxylamines having at least one OH function include for example: ethanolamine, propanolamine, alkylethanolamines, arylethanolamine, alkylpropanolamine, such as for example: diethanolamine, monoethanolamine, diisopropanolamine, isopropanolamine, methylisopropanolamine, diglycolamine (2-(2-aminoethoxy)ethanol), dimethylethanolamine, N-(2-hydroxyethyl)aniline, 1-(2-hydroxyethyl)piperazine, 2-(2-aminoethoxy)ethanol, 3-amino-1-propanol, 5-amino-1-pentanol, butylethanolamine, ethylethanolamine, N-methylethanolamine, aminopropylmonomethylethanolamine, 2-amino-2-methylpropanol, trishydroxymethylaminomethane (THMAM or TRIS), N-(2-aminoethyl)ethanolamine (AEEA). It is also possible to use corresponding alkoxylates, especially ethoxylates and/or propoxylates of amines, for example alkylamines having a hydroxyethyl or hydroxypropyl unit or, for example, N-hydroxyethylcyclohexyldiamine, N-hydroxyethylisophoronediamine, N-hydroxyethylpiperazine, bis(hydroxyethyl)toluenediamine.

Particular preference is given to amides as described in EP 2511315 A1 and EP 1985642 A1 and based on monoethanolamine (MEA) or diethanolamine (DEA), such as for example: cocamide DEA, cocamide MEA, cocamide MIPA, soyamide DEA, undecenylamide DEA, oleamide DEA, oleamide MEA, lauramide DEA, lauramide MEA, PEG-5 cocamide, PEG-3 oleamide, PEG-6 lauramide, ethoxylated isopropanolamide, conversion products of tall oil acid and diethylenetriamine (DETA) to amide or imidazole.

In a further preferred embodiment, the Si-free surfactants are imidazoles. They may for example be prepared by reacting the carboxylic acids with (2-aminoethylamino)ethanol (AEEA). These are known as intermediates in the preparation of betaines or quats. Examples of suitable imidazoles include the following compounds: 1-hydroxyethyl-2-heptadecenylimidazoline, 1-hydroxyethyl-2-norcocoalkylimidazoline, 1-hydroxyethyl-2-norlaurylimidazoline, 1-hydroxyethyl-2-heptylimidazoline.

In a further preferred embodiment, the Si-free surfactants are oxazolines. They may for example be prepared by reacting the carboxylic acids with amino alcohols. Examples of suitable oxazolines include the following compounds: 2-(heptadecenyl)-2-oxazoline-4,4-dimethanol or 4-ethyl-2-(8-heptadecenyl)-2-oxazoline-4-methanol.

In a further preferred embodiment, the Si-free surfactants are amide amines. In the context of the invention, these rank among the abovementioned amides. They may for example be prepared by reacting the carboxylic acids with dimethylaminopropylamine (DMAPA) or with 2-(2-aminoethylamino)ethanol (AEEA). Amide amines based on DMAPA are common intermediates in the preparation of betaines or quats (quaternary ammonium compounds), which are suitable as Si-free surfactants. Examples of suitable amide amines include: castor oil amide amine, coconut fatty acid amide amine, stearic acid amide amine, behenic acid amide amine, lauric acid amide amine, in particular those amide amines that are based on 3-dimethylaminopropylamine or on 2-(2-aminoethylamino)ethanol.

In a further preferred embodiment, the Si-free surfactants are alcohol alkoxylates. Processes for preparing alcohol alkoxylates are known to those skilled in the art. The alcohol alkoxylates are preferably obtained by reacting alcohols with alkylene oxides. Preferably, the Si-free surfactant is thus an alcohol alkoxylate preparable by reacting alcohols with alkylene oxides. The alkylene oxides add onto the alcohol with ring opening. The alcohols may be linear or branched, saturated or unsaturated, aliphatic or aromatic, cyclic or acyclic. The alcohols may also comprise one or more hydroxyl groups. The alkylene oxides are in turn preferably selected from the group consisting of ethylene oxide (EO), propylene oxide (PO), butylene oxide (BO) and styrene oxide (SO). The alkylene oxides may be added either individually in pure form, in alternating succession in any metering sequence, or else simultaneously in mixed form. This determines the sequence of the oxyalkylene units or alkyleneoxy units as repeating units in the polyether chain that forms. By the process, it is possible to construct polyether chains having the feature of controlled and reproducible preparability in terms of structure and molar mass. The sequence of repeating units can be varied by the sequence of addition of the alkylene oxides within broad limits. It is particularly preferable here for the preparation of the alcohol alkoxylates to involve reacting alcohols having 4 to 36 carbon atoms with alkylene oxide units selected from the group consisting of ethylene oxide (EO), propylene oxide (PO), butylene oxide (BO) and styrene oxide (SO), with an average of 3 to 150 alkylene oxide units used per hydroxyl group of the alcohol. Examples of suitable alkoxylates include: PPG-14 butyl ether, PPG-3 myristyl ether, PPG-15 stearyl ether, PEG-40 hydrogenated castor oil, isoceteth-20, laureth-4, steareth-2, PEG-6 caprylic/capric glyceride, C9-alcohol ethoxylates, lauryl alcohol alkoxylate, tridecyl alcohol ethoxylate having 6 to 36 EO, mono-, di-, tristyrylphenol ethoxylates, alkylphenol ethoxylates. Suitable alcohol alkoxylates are known for example under the name Tomadol® (Evonik) or Nonidet® (Shell Chemical Co.). Suitable alcohol alkoxylates containing BO or SO are described for example in DE 19940797 A1. Suitable alcohol alkoxylates based on diols as starter are likewise known. The diol may be used as starter directly or be formed indirectly from the reaction of water as starter with an alkylene oxide. These alcohol alkoxylates preferably have a blockwise arrangement of the oxyalkylene units and are known for example under the name Pluronics® (BASF) or Vorasurf® (Dow Chemical Company). Pluronics® for example are (OH-terminated) block copolymers of EO and PO. These compounds are also referred to as poloxamers and have a triblock structure (EO-PO-EO). Vorasurf® 504 is for example an (OH-terminated) block copolymer of EO and BO, as described for example in EP 0734404 A1.

In a further preferred embodiment, the Si-free surfactants are alkoxylated amines. Processes for preparing alkoxylated amines are known to those skilled in the art. The alkoxylated amines are preferably obtained by reacting amines with alkylene oxides. The alkylene oxides add onto the amine with ring opening. The amines may be linear or branched, aliphatic or aromatic, cyclic or acyclic. The amines may also comprise one or more amino groups. The amino groups are preferably primary and/or secondary amino groups. The amines preferably have 4 to 36 carbon atoms. Particular preference is given to talcamine and cocoamine. The alkylene oxides are in turn preferably selected from the group consisting of ethylene oxide (EO), propylene oxide (PO), butylene oxide (BO) and styrene oxide (SO). The alkylene oxides may be added either individually in pure form, in alternating succession in any metering sequence, or else simultaneously in mixed form. This determines the sequence of the oxyalkylene units or alkyleneoxy units as repeating units in the polyether chain that forms. By the process, it is possible to construct polyether chains having the feature of controlled and reproducible preparability in terms of structure and molar mass. The sequence of repeating units can be varied by the sequence of addition of the alkylene oxides within broad limits. Examples of alkoxylated amines that are suitable as Si-free surfactants include ethoxylated talcamine and ethoxylated cocoamine, in particular those compounds obtained by reacting 2 to 15 mol of ethylene oxide per 1 mol of talcamine or cocoamine.

In a further preferred embodiment, the Si-free surfactants are novolak-based surfactants as described for example in the examples of DE 3724716 C1 as foam stabilizer A.

In a further preferred embodiment, the Si-free surfactants are compounds based on hydrogenated or partially hydrogenated, optionally alkoxylated ketone-aldehyde resins as described in EP 3320012 B1.

Likewise suitable as Si-free surfactants are polymers based on N-vinylpyrrolidone and dibutyl maleate as described in U.S. Pat. No. 3,746,663.

Likewise suitable as Si-free surfactants are polymers of N-vinylpyrrolidone as described in DE 2244350 A1.

Polyamine- or polyimine-based compounds may also be used as Si-free surfactants, as described for example in EP 3222650 A1.

Further polymeric structures that are suitable as Si-free surfactants are described in EP 1790682 A1 and DE 102006042338 A1.

EP 1790682 A1 describes the use of grafted polyether copolymers for the stabilization of polyurethane foams, these being suitable as Si-free surfactants.

DE 102006042338 A1 describes the use of urethane- or urea-group-containing polyethers for the stabilization of polyurethane foams, these likewise being suitable as Si-free surfactants.

EP 1790682 A1 and DE 102006042338 A1 disclose further Si-free foam stabilizers that here too can be used as Si-free surfactants for the stabilization of PU foams.

In summary, it can be stated that the Si-free surfactant preferably is or comprises a carboxylic acid derivative selected from the group consisting of esters, amides, imides, imidazolines and oxazolines, and/or a polyether compound. The polyether compound has at least 2, preferably 2 to 100, especially 3 to 50, ether groups. More preferably still, the Si-free surfactant is a carboxylic acid derivative selected from the group consisting of esters, amides, imides, imidazolines and oxazolines, or is or comprises an alcohol alkoxylate preparable by reacting alcohols with alkylene oxides. The carboxylic acid derivatives are thus for example carboxylic esters or carboxamides. The alcohol alkoxylates are preferably based, as described above, on monools or diols.

Si-free surfactant and the hydrocarbons HC can be used in mixed form in any mass ratios. There are therefore no restrictions concerning the mass ratios. However, it is preferable for the hydrocarbons HC to be used in combination with Si-free surfactant in a mass ratio of 1:4 to 1:200 in the composition according to the invention. The mass ratio is the ratio of the mass of the entirety of all hydrocarbons HC to the mass of the entirety of all Si-free surfactants in the composition according to the invention.

In addition to the Si-free surfactants, Si-containing surfactants may also in principle be used. However, it is preferable for no Si-containing surfactants to be used and for the composition according to the invention not to comprise any Si-containing surfactants.

In a particularly preferred embodiment of the invention, polyalkylsiloxanes (PAS) are additionally also used, in which case mixtures or combinations of hydrocarbons (HC), polyalkylsiloxanes (PAS) and Si-free surfactants (SifS) are thus used.

It is thus preferable for the composition according to the invention to additionally comprise polyalkylsiloxanes (PAS).

It is preferable for the polyalkylsiloxanes to contain fewer than 20, more preferably still fewer than 15 and particularly preferably fewer than 11 Si atoms. It is moreover preferable for the polyalkylsiloxanes to comprise at least 2 Si atoms. It is thus preferable for the polyalkylsiloxanes to contain fewer than 20, more preferably still fewer than 15 and particularly preferably fewer than 11 Si atoms and in each case to comprise at least 2 Si atoms.

It is further preferable for the polyalkylsiloxanes in relation to the Si-free surfactant to preferably be used in a mass ratio of 1:5 to 1:200. The mass ratio is the ratio of the mass of the entirety of all polyalkylsiloxanes to the mass of the entirety of all Si-free surfactants in the composition according to the invention.

In a preferred embodiment, the composition according to the invention thus additionally comprises polyalkylsiloxanes, where the polyalkylsiloxanes contain preferably fewer than 20, more preferably fewer than 15 and particularly preferably fewer than 11 silicon atoms, and where the polyalkylsiloxanes in relation to the Si-free surfactant are preferably used in a mass ratio of 1:5 to 1:200.

It is preferable for the proportion by mass of the total amount of hydrocarbons HC, Si-free surfactant and optional polyalkylsiloxanes, based on 100 parts by mass of polyol component, to be from 0.1 to 10 pphp, preferably from 0.5 to 5 pphp and particularly preferably from 1 to 3 pphp.

In a preferred embodiment of the invention, the polyalkylsiloxanes conform to the formula 1:

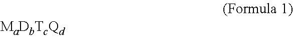

where
M=R¹¹R¹²R¹³SiO_{1/2}
D=R¹⁴R¹⁵SiO_{2/2}
T=R¹⁶SiO_{3/2}
Q=SiO_{4/2}
where
R¹¹, R¹², R¹³, R¹⁴, R¹⁵, R¹⁶=identical or different hydrocarbon radicals having 1 to 12, preferably 1 to 8, carbon atoms, where the hydrocarbon radicals are optionally substituted by heteroatoms, or else H,
especially preferably the radicals: phenyl-, CH₃—, CH₃CH₂—, CH₂CH—, ClCH₂CH₂CH₂— and H—,
and wherein
a=2 to 6
b=0 to 8,
c=0 to 4,
d=0 to 2,
with the proviso that a+b+c+d<20, preferably <15, especially preferably <11.

Preferably, c+d>0.5. Particularly preferably, c+d>=1.

Preferably, d=0 and c>0.5. Particularly preferably, d=0 and c is greater than or equal to 1.

Preferably, c+d<0.5. Particularly preferably, c+d<0.1.

In a further preferred embodiment, R¹⁶ is different from R¹¹, R¹², R¹³, R¹⁴ and R¹⁵.

In a further preferred embodiment, R¹¹, R¹², R¹³ are different, and so the M unit in the siloxane bears two or three different radicals.

Preferred polyalkylsiloxanes conform to the formula 2:

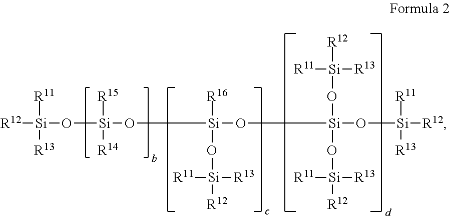

with R¹¹ to R¹⁶ and b, c, d being as specified above.

Preferred polyalkylsiloxanes of the formula 2 conform to the formula 3 or 4:

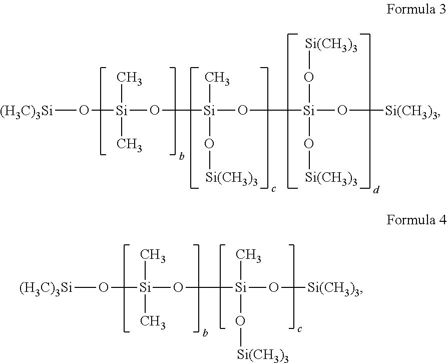

with b, c, d being as specified above.

Preferred polyalkylsiloxanes are as follows:

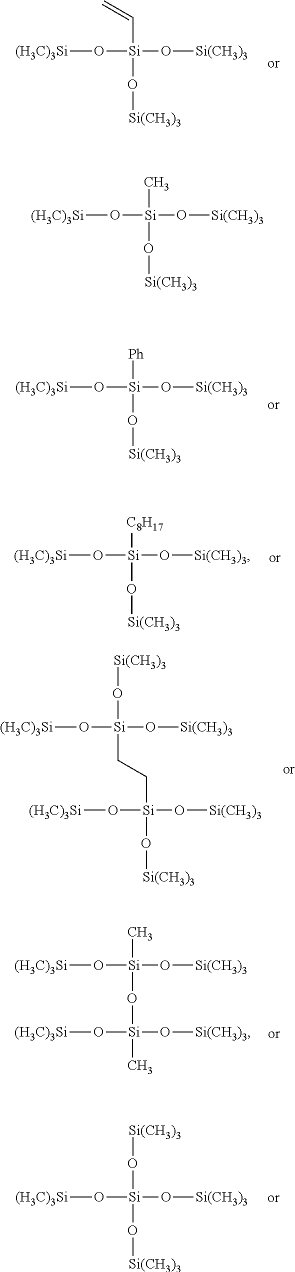

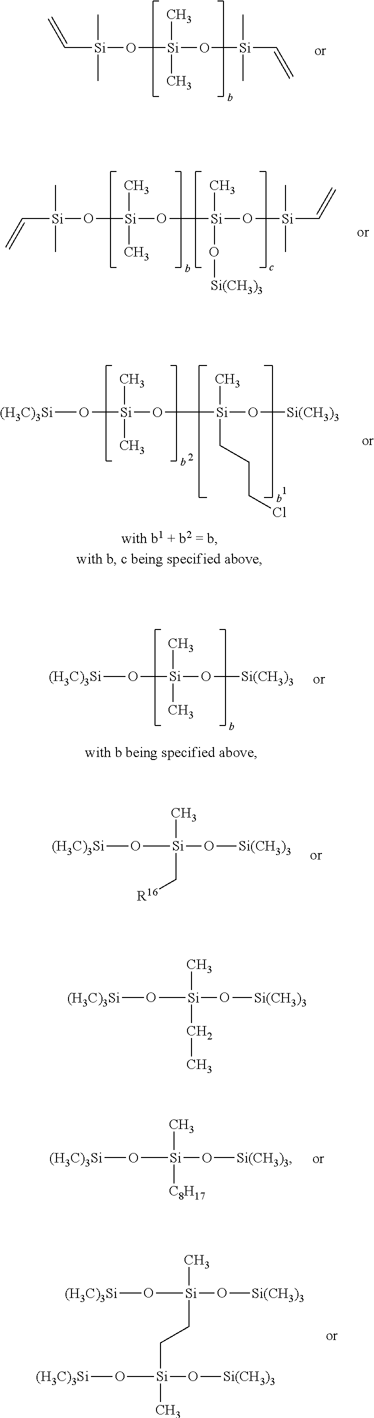

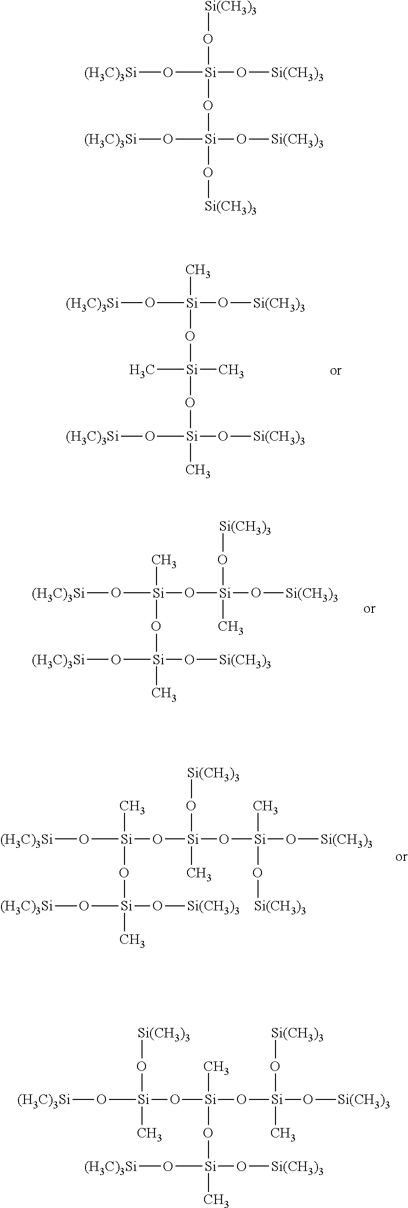

The hydrocarbons HC, Si-free surfactants and optional polyalkylsiloxanes (PAS) usable in accordance with the invention may also be used as part of compositions with different carrier media.

Examples of useful carrier media include glycols, alkoxylates or oils of synthetic and/or natural origin. In a preferred embodiment of the invention, the total proportion by mass of hydrocarbons HC, Si-free surfactants (SifS) and optional polyalkylsiloxanes (PAS) in the finished polyurethane foam is from 0.01% to 10% by weight, preferably from 0.1% to 3% by weight.

The combinations according to the invention of hydrocarbons HC, Si-free surfactants SifS and optional polyalkylsiloxanes are also referred to hereinafter as “mixture”, irrespective of whether the components are supplied separately or together to the reaction mixture for production of the PU foam.

As already explained, the composition of the invention for production of polyurethane foam comprises at least one polyisocyanate component, a polyol component, optionally a catalyst that catalyses the formation of a urethane or isocyanurate bond, optionally blowing agents, where the composition additionally comprises hydrocarbons HC that have boiling points at standard pressure of >100° C., preferably >150° C., and Si-free surfactant.

The composition can comprise one or more polyisocyanate components, one or more polyol components, optionally one or more catalysts that catalyse the formation of a urethane or isocyanurate bond, and optionally one or more blowing agents, where the composition additionally comprises one or more hydrocarbons HC that have boiling points at standard pressure of >100° C., preferably >150° C., and one or more Si-free surfactants.

The mixture according to the invention of hydrocarbons HC, Si-free surfactants SifS and optional polyalkylsiloxanes has the advantage of producing polyurethane or polyisocyanurate foams, more particularly rigid foams, which are marked by a good fine-cell content and good insulating properties and at the same time have little by way of foam defects.

Preferred compositions according to the invention that are suitable for production of polyurethane or polyisocyanurate foams contain at least one polyisocyanate component, at least one polyol component, at least one foam stabilizer, at least one urethane and/or isocyanurate catalyst, blowing agent, and optionally at least one flame retardant and/or further additives, and are notable in that at least one mixture according to the invention of hydrocarbons HC, Si-free surfactants SifS and optional polyalkylsiloxanes is present.

A preferred composition of the invention thus contains the following constituents:
(a) one or more polyol components
(b) one or more polyisocyanate components
(c) optionally one or more catalysts
(d) a mixture of one or more hydrocarbons HC, one or more Si-free surfactants SifS and optionally one or more polyalkylsiloxanes PAS
(e) optionally one or more blowing agents
(f) optionally one or more additives preferably selected from the group consisting of fillers and flame retardants.

A preferred composition according to the invention accordingly comprises:
(a) one or more polyol components
(b) one or more polyisocyanate components
(c) optionally one or more catalysts
(d1) one or more hydrocarbons HC
(d2) one or more Si-free surfactants SifS
(d3) optionally one or more polyalkylsiloxanes PAS
(e) optionally one or more blowing agents
(f) optionally one or more additives preferably selected from the group consisting of fillers and flame retardants.

In the composition according to the invention, the proportion by mass of mixture according to the invention (i.e. hydrocarbons HC, Si-free surfactants SifS and optional polyalkylsiloxanes PAS) d), based on 100 parts by mass of polyol component a), is preferably from 0.1 to 10 pphp, more preferably from 0.5 to 5 pphp and especially preferably from 1 to 3 pphp.

Polyol components (a) used are one or more compounds comprising OH groups, SH groups, NH groups and/or NH₂ groups and having a functionality of 1.8 to 8. The polyol component comprises at least one compound having at least two isocyanate-reactive groups selected from OH groups, SH groups, NH groups and/or NH₂ groups, especially OH groups.

A functionality of 1.8, for example, may arise as a result of at least one compound having a relatively high functionality, for example of greater than or equal to 2, being mixed with at least one compound having a functionality of, for example, 1. This may happen in particular when using a polyisocyanate component (b) having a functionality of greater than 2 or additional crosslinkers as optional additives (f).

Suitable compounds in the context of this invention are all organic substances comprising OH groups, SH groups, NH groups and/or NH₂ groups, especially OH groups, and mixtures thereof having a functionality of 1.8 to 8.

Appropriate compounds which may typically be used when producing PU foams are known to those skilled in the art and for example described in “Kunststoffhandbuch, Band 7, Polyurethane [Plastics Handbook, volume 7, Polyurethanes]”, Carl Hanser Verlag, 3rd Edition 1993, Chapter 3.1.

It is preferable to use compounds having OH numbers within a range from 10 to 1200 mg KOH/g. The OH number is preferably determined either in accordance with the standard DIN EN ISO 4629-1:2016-12 (without catalyst) or in accordance with the standard DIN EN ISO 4629-2:2016-12 (with catalyst).

It is preferable for the polyols or the polyol component to have a number-average molecular weight from 500 to 15 000 g/mol. The number-average molecular weight may for example be determined by means of gel permeation chromatography (GPC), preferably in accordance with the standard DIN EN ISO 13885-1:2021-11 (THF as eluent), in accordance with the standard DIN EN ISO 13885-2:2021-11 (acrylamide as eluent) or in accordance with the standard ISO 13885-3:2020-07 (water as eluent), particularly preferably in accordance with DIN EN ISO 13885-1:2021-11 (THF as eluent).

The polyols or the polyol component preferably has/have a functionality of 1.8 to 8 and number-average molecular weights in the range from 500 to 15 000 g/mol. It is preferable to use polyols having OH values within the range from 10 to 1200 mg KOH/g, more preferably having OH values within the range from 30 to 800, more preferably still having OH values within the range from 50 to 600, in particular within the range from 80 to 500 mg KOH/g.

Particularly preferred compounds are all polyether polyols and polyester polyols typically used for production of polyurethane systems, especially polyurethane foams.

In addition, it is possible to use polyether polycarbonate polyols, polyols based on natural oils (natural oil based polyols, NOPs; e.g. described in WO 2005/033167, US 2006/0293400, WO 2006/094227, WO 2004/096882, US 2002/0103091, WO 2006/116456, EP 1678232), filled polyols, prepolymer-based polyols and/or recycled polyols.

Recycled polyols are polyols that are obtained from the chemical recycling of polyurethanes, for example by solvolysis, for example glycolysis, hydrolysis, acidolysis or aminolysis. The use of recycled polyols constitutes a particularly preferred embodiment of the invention.

Polyether polyols are obtainable by known methods, for example by anionic polymerization of alkylene oxides in the presence of alkali metal hydroxides, alkali metal alkoxides or amines as catalysts and by addition of at least one starter molecule which preferably contains 2 or 3 reactive hydrogen atoms in bonded form, or by cationic polymerization of alkylene oxides in the presence of Lewis acids, for example antimony pentachloride or boron trifluoride etherate, or by double metal cyanide catalysis. Suitable alkylene oxides contain 2 to 4 carbon atoms in the alkylene radical. Examples are tetrahydrofuran, 1,3-propylene oxide and 1,2- or 2,3-butylene oxide; preference is given to using ethylene oxide and 1,2-propylene oxide. The alkylene oxides may be used individually, cumulatively, in blocks, in alternating succession or as mixtures. Starter molecules used may in particular be compounds having at least 2, preferably 2 to 8, hydroxyl groups, or having at least two primary amino groups in the molecule. Starter molecules used may, for example, be water, di-, tri- or tetrahydric alcohols such as ethylene glycol, propane-1,2- and -1,3-diol, diethylene glycol, dipropylene glycol, glycerol, trimethylolpropane, pentaerythritol, castor oil, etc., higher polyfunctional polyols, especially sugar compounds, for example glucose, sorbitol, mannitol and sucrose, polyhydric phenols, resols, for example oligomeric condensation products of phenol and formaldehyde and Mannich condensates of phenols, formaldehyde and dialkanolamines, and also melamine, or amines such as aniline, EDA, TDA, MDA and PMDA, more preferably TDA and PMDA. The choice of suitable starter molecule depends on the respective field of application of the resulting polyether polyol in polyurethane production.

Polyester polyols are based on esters of polybasic aliphatic or aromatic carboxylic acids, preferably having 2 to 12 carbon atoms. Examples of aliphatic carboxylic acids are succinic acid, glutaric acid, adipic acid, suberic acid, azelaic acid, sebacic acid, decanedicarboxylic acid, maleic acid and fumaric acid. Examples of aromatic carboxylic acids are phthalic acid, isophthalic acid, terephthalic acid and the isomeric naphthalenedicarboxylic acids. The polyester polyols are obtained by condensation of these polybasic carboxylic acids with polyhydric alcohols, preferably diols or triols having 2 to 12, particularly preferably having 2 to 6, carbon atoms, preferably trimethylolpropane and glycerol.

In a particularly preferred embodiment, polyester polyols based on aromatic carboxylic acids are used at more than 50 pphp, preferably more than 70 pphp, based on 100 parts by mass of polyol component.

It is a particularly preferred embodiment of the invention when polyester polyols having melting points of less than 30° C. are used.

In a further very particularly preferred embodiment, no polyols based on phenolic resins prepared from novolaks and alkylene oxides and no polyols based on aromatic amine polyols prepared by alkoxylation of aromatic amines are used, which means that, in this preferred embodiment, less than 20 pphp, preferably less than 10 pphp, especially less than 2 pphp and most advantageously no polyols at all based on phenolic resins prepared from novolaks and alkylene oxides and no polyols at all based on aromatic amine polyols prepared by alkoxylation of aromatic amines are used.

Polyether polycarbonate polyols are polyols containing carbon dioxide bound in the form of carbonate. Since carbon dioxide is formed in large amounts as a by-product in many processes in the chemical industry, the use of carbon dioxide as comonomer in alkylene oxide polymerizations is of particular interest from a commercial viewpoint. Partial replacement of alkylene oxides in polyols with carbon dioxide has the potential to distinctly lower costs for the production of polyols. Moreover, the use of CO₂ as comonomer is environmentally very advantageous, since this reaction constitutes the conversion of a greenhouse gas into a polymer. The preparation of polyether polycarbonate polyols by addition of alkylene oxides and carbon dioxide onto H-functional starter substances with the use of catalysts has long been known. Various catalyst systems may be used here: The first generation was that of heterogeneous zinc or aluminium salts, as described, for example, in U.S. Pat. No. 3,900,424 or U.S. Pat. No. 3,953,383. In addition, mono- and binuclear metal complexes have been successfully used for copolymerization of CO₂ and alkylene oxides (WO 2010/028362, WO 2009/130470, WO 2013/022932 or WO 2011/163133). The most important class of catalyst systems for the copolymerization of carbon dioxide and alkylene oxides is that of double metal cyanide catalysts, also referred to as DMC catalysts (U.S. Pat. No. 4,500,704, WO 2008/058913). Suitable alkylene oxides and H-functional starter substances are those also used for preparing carbonate-free polyether polyols, as described above.

Polyols based on renewable raw materials, natural oil-based polyols (NOPs), for production of polyurethane foams are of increasing interest with regard to the long-term limits in the availability of fossil resources, namely oil, coal and gas, and against the background of rising crude oil prices, and have already been described many times in such applications (WO 2005/033167; US 2006/0293400, WO 2006/094227, WO 2004/096882, US 2002/0103091, WO 2006/116456 and EP 1678232). A number of these polyols are now commercially available from various manufacturers (WO 2004/020497, US 2006/0229375, WO 2009/058367). Depending on the base raw material (e.g. soybean oil, palm oil or castor oil) and subsequent processing, polyols having different profiles of properties are obtained. A distinction may essentially be made between two groups: a) polyols based on renewable raw materials that are modified such that they may be used to an extent of 100% in the production of polyurethanes (WO 2004/020497, US 2006/0229375); b) polyols based on renewable raw materials that on account of their processing and properties are able to replace the petrochemical-based polyol only up to a certain proportion (WO 2009/058367).

A further class of usable polyols is that of “filled polyols” (polymer polyols). The characteristic feature of these is that they contain dispersed solid organic fillers up to a solids content of 40% or more. Usable polyols include SAN, PUD and PIPA polyols. SAN polyols are highly reactive polyols containing a dispersed copolymer based on styrene-acrylonitrile (SAN). PUD polyols are highly reactive polyols containing polyurea, likewise in dispersed form. PIPA polyols are highly reactive polyols containing a dispersed polyurethane, for example formed by in situ reaction of an isocyanate with an alkanolamine in a conventional polyol.

A further class of usable polyols is that of polyols obtained as prepolymers through reaction of polyol with isocyanate in a molar ratio of preferably 100:1 to 5:1, more preferably 50:1 to 10:1. Such prepolymers are preferably made up in the form of a solution in polymer, with the polyol preferably corresponding to the polyol used for preparing the prepolymers.

Polyisocyanate components (b) used are generally one or more polyisocyanates having two or more isocyanate groups. Suitable polyisocyanates for the purposes of the present invention are all organic isocyanates having two or more isocyanate groups, in particular the aliphatic, cycloaliphatic, arylaliphatic and preferably aromatic polyfunctional isocyanates known per se.

Examples that may be mentioned here are alkylene diisocyanates having 4 to 12 carbon atoms in the alkylene radical, for example dodecane 1,12-diisocyanate, 2-ethyltetramethylene 1,4-diisocyanate, 2-methylpentamethylene 1,5-diisocyanate, tetramethylene 1,4-diisocyanate, pentamethylene diisocyanate (PDI) and preferably hexamethylene 1,6-diisocyanate (HMDI), cycloaliphatic diisocyanates such as cyclohexane 1,3- and 1,4-diisocyanate and the corresponding isomer mixtures, methylene dicyclohexyl 4,4′-diisocyanate (H12MDI), isophorone diisocyanate (IPDI), methylcyclohexyl 2,4- and 2,6-diisocyanate and the corresponding isomer mixtures, and preferably aromatic diisocyanates and polyisocyanates such as toluene 2,4- and 2,6-diisocyanate (TDI) and the corresponding isomer mixtures, naphthalene diisocyanate, diethyltoluene diisocyanate, diphenylmethane 4,4′- or 2,2′- or 2,4′-diisocyanate (MDI) and polymethylene polyphenyl polyisocyanate (PMDI, “polymeric MDI”). The organic polyisocyanates may be used individually or in the form of mixtures thereof. It is likewise possible to use corresponding “oligomers” of the diisocyanates, such as the IPDI trimer based on the isocyanurate, biurets or uretdiones. Furthermore, the use of prepolymers based on the abovementioned isocyanates is possible. The mixture of MDI and more highly condensed analogues having an average functionality of 2 to 4 which is known as polymeric MDI (also referred to as “crude MDI”) is particularly suitable, as well as the various isomers of TDI in pure form or as isomeric mixture. It is also possible to use isocyanates which have been modified by the incorporation of urethane, uretdione, isocyanurate, allophanate and other groups, known as modified isocyanates. Examples of particularly suitable isocyanates are also detailed for example in EP 1712578, EP 1161474, WO 00/58383, US 2007/0072951, EP 1678232 and WO 2005/085310, which are hereby fully incorporated by reference.

A preferred ratio of polyisocyanate component (b) and polyol component (a), expressed as the index of the formulation, i.e. as the stoichiometric ratio of isocyanate groups to isocyanate-reactive groups (e.g. OH groups, NH groups) multiplied by 100, is in the range from 10 to 1000, preferably 40 to 700, more preferably from 150 to 550, especially preferably from 200 to 500. An index of 100 represents a molar ratio of reactive groups of 1:1.

In a preferred embodiment of the invention, the index of the formulation is in the range from 150 to 550, more preferably 200 to 500. This means that, in a preferred embodiment, a distinct excess of isocyanate groups over isocyanate-reactive groups is present. This results in trimerization reactions of the isocyanates, which thus form isocyanurates. These foam types are also referred to as polyisocyanurate (PIR) foams and are notable for improved fire characteristics, i.e. poorer burning. These foam types are preferred subject-matter of the invention. Particularly preferably, the polyol component (a) comprises one or more polyester polyols.

Suitable catalysts (c) which are usable for the production of polyurethanes, in particular PU foams, are known to those skilled in the art from the prior art. Usable compounds in the context of the present invention are all compounds capable of catalysing the reaction of isocyanate groups with OH groups, NH groups or other isocyanate-reactive groups, and the reaction of isocyanate groups with one another.

It is possible to employ here the customary catalysts known from the prior art, including for example amines (cyclic or acyclic; monoamines, diamines, oligomers having one or more amino groups), ammonium compounds, metal-organic compounds and/or metal salts, preferably of tin, iron, bismuth, potassium and/or zinc. In particular, catalysts used may be mixtures of two or more compounds of this kind.

As component (d), the mixtures according to the invention (i.e. hydrocarbons HC, Si-free surfactants SifS and optional polyalkylsiloxanes PAS) are used.

In a further preferred embodiment, the total amount of the mixture used (i.e. the entirety of all hydrocarbons HC, Si-free surfactants and optional polyalkylsiloxanes) is such that the proportion by mass based on the finished polyurethane is 0.01% to 10% by weight, preferably 0.1% to 3% by weight.

Blowing agents and the use thereof in the production of PU foams are known to those skilled in the art. The use of a blowing agent (e) or of a combination of two or more blowing agents (e) depends in principle on the nature of the foaming process used, on the nature of the system and on the use for the PU foam obtained. Chemical and/or physical blowing agents may be used, as well as a combination of the two. Depending on the amount of blowing agent used, a foam having high or low density is produced. For instance, foams can be produced having densities of 5 to 900 kg/m³, preferably 5 to 350 kg/m³, particularly preferably 8 to 200 kg/m³, especially 8 to 150 kg/m³.

Physical blowing agents that may be used are any appropriate compounds having suitable boiling points and mixtures thereof, for example hydrocarbons having 3, 4 or 5 carbon atoms, preferably cyclo-, iso-, n-pentane, hydrofluorocarbons (HFCs), preferably HFC 245fa, HFC 134a or HFC 365mfc, hydrochlorofluorocarbons (HCFCs), preferably HCFC 141b, hydrofluoroolefins (HFOs) or hydrohaloolefins, preferably 1234ze, 1234yf, 1224yd, 1233zd(E) or 1336mzz, esters, preferably methyl formate, ketones, preferably acetone, ethers, preferably dimethoxymethane, or chlorinated hydrocarbons, preferably dichloromethane or 1,2-dichloroethane. It is a particularly preferred embodiment of the invention when hydrocarbons having 3, 4 or 5 carbon atoms, preferably having 4 or 5 carbon atoms, in particular having 5 carbon atoms, are used, with preference being given to not using any halogenated blowing agents.

Chemical blowing agents that may be used are any compounds that react with NCO groups with the release of gases, such as for example water or formic acid, or which release gases during the reaction as a result of the rise in temperature, such as for example sodium hydrogencarbonate.

It is a particularly preferred embodiment of the invention when the composition according to the invention contains, as blowing agent, water in a combination with hydrocarbons having 5 carbon atoms, HFOs, hydrohaloolefins or HFCs or mixtures thereof. It is a very particularly preferred embodiment of the invention when the blowing agents used are just water in combination with hydrocarbons having 5 carbon atoms.

Suitable water contents for the purposes of this invention depend on whether or not one or more blowing agents are used in addition to the water. In the case of purely water-blown foams, preferred values are typically 1 to 20 pphp; when other blowing agents are used in addition, the preferred use amount is reduced to typically 0.1 to 5 pphp.

As additives (f), it is possible to use all substances which are known from the prior art and are used in the production of polyurethanes, especially polyurethane foams, for example crosslinkers and chain extenders, stabilizers against oxidative degradation (known as antioxidants), flame retardants, surfactants, biocides, cell-refining additives, cell openers, solid fillers, antistatic additives, nucleating agents, thickeners, dyes, pigments, colour pastes, fragrances, and emulsifiers etc.

As flame retardant, the composition according to the invention can contain any known flame retardants suitable for the production of PU foams, such as for example halogen-containing or halogen-free organic phosphorus-containing compounds, such as for example triethyl phosphate (TEP), tris(1-chloro-2-propyl) phosphate (TCPP, also referred to as tris(2-chloroisopropyl) phosphate), tris(2-chloroethyl) phosphate (TCEP), dimethyl methanephosphonate (DMMP), dimethyl propanephosphonate (DMPP), ammonium polyphosphate or red phosphorus, nitrogen-containing compounds such as for example melamine, melamine cyanurate or melamine polyphosphate or halogenated compounds such as for example chlorinated and/or brominated polyether polyols and/or polyester polyols. It is also possible to use mixtures of different flame retardants. The flame retardants are preferably liquid flame retardants.

The invention further provides a process for producing polyurethane foam by reacting one or more polyol components with one or more polyisocyanate components, characterized in that the reaction is effected in the presence of hydrocarbons HC, Si-free surfactant and optionally polyalkylsiloxanes, especially using the composition according to the invention.

The invention thus further provides a process for producing polyurethane foam by reacting one or more polyol components with one or more polyisocyanate components, characterized in that the reaction is effected in the presence of one or more hydrocarbons HC, one or more Si-free surfactants and optionally one or more polyalkylsiloxanes, especially using the composition according to the invention.

It is preferable here for the components hydrocarbons HC, Si-free surfactant and optional polyalkylsiloxanes to be supplied separately or together to the reaction mixture for production of the polyurethane foam.

The process according to the invention for producing PU foams can be conducted by any known methods, for example by manual mixing or preferably by means of foaming machines. If the process is conducted using foaming machines, it is possible to use high-pressure or low-pressure machines. The process according to the invention can be carried out either batchwise or continuously and it is possible for example to use 1K, 1.5K or 2K systems as described in EP 3717538 A1, U.S. Pat. No. 7,776,934 B2, EP 1400547 B1 or EP 2780384 B2.

A preferred polyurethane or polyisocyanurate foam formulation in the context of this invention gives a foam density of from 5 to 900 kg/m³ and has the composition shown in Table 1.

TABLE 1
Composition of a preferred polyurethane
or polyisocyanurate foam formulation

| | Proportion |
|---|---|
| Component | by weight |
| Polyol | 0.1 to 100 |
| Amine catalyst | 0 to 5 |
| Metal catalyst | 0 to 10 |
| Hydrocarbons HC, Si-free surfactants and optional | 0.1 to 10 |
| polyalkylsiloxanes | |
| Water | 0.01 to 20 |
| Blowing agent | 0 to 40 |
| Further additives (flame retardants, etc.) | 0 to 90 |
| Isocyanate index: 10 to 1000 | |

For further preferred embodiments and configurations of the process according to the invention, reference is also made to the details already given above in connection with the composition according to the invention. These details are preferably applicable.

The invention further provides a polyurethane foam obtainable by the process mentioned.

In a preferred embodiment of the invention, the polyurethane foam has a foam density of 5 to 900 kg/m³, preferably 8 to 800 kg/m³, more preferably 10 to 600 kg/m³, especially 30 to 150 kg/m³.

The polyurethane foam (PU foam) according to the invention is preferably a rigid polyurethane foam (rigid PU foam).

Rigid polyurethane foam or rigid PU foam is an established technical term. The known and fundamental difference between flexible foam and rigid foam is that flexible foam shows elastic characteristics and hence deformation is reversible. By contrast, rigid foam is permanently deformed. In the context of the present invention, rigid polyurethane foam is especially understood to mean a foam to DIN 7726 that has a compressive strength to DIN 53 421/DIN EN ISO 604 of advantageously 20 kPa, preferably 80 kPa, more preferably ≥100 kPa, further preferably ≥150 kPa, especially preferably ≥180 kPa. Preferably, the rigid polyurethane foam, according to DIN ISO 4590, advantageously has a closed-cell content of greater than 50%, preferably greater than 80% and more preferably greater than 90%. Further details regarding rigid polyurethane foams can also be found in “Kunststoffhandbuch, Band 7, Polyurethane [Plastics Handbook, volume 7, Polyurethanes]”, Carl Hanser Verlag, 3rd Edition 1993, Chapter 6.

The PU foams, especially rigid PU foams, can be used as or for production of insulation materials, preferably insulation boards, refrigerators, insulating foams, roof liners, packaging foams or spray foams.

The present invention thus further provides for the use of polyurethane or polyisocyanurate foams according to the invention as insulation boards and/or insulant, preferably for cooling apparatuses. The cooling apparatuses preferably include the polyurethane or polyisocyanurate foam according to the invention as insulation material.

The PU foams according to the invention can be used advantageously particularly in the refrigerated warehouse, refrigeration appliances and domestic appliances industry, for example for production of insulation boards for roofs and walls, as insulation material in containers and warehouses for frozen goods, and for refrigeration and freezing appliances.

Further preferred fields of use are in vehicle construction, especially for production of vehicle inner roof liners, bodywork parts, interior trim, cooled vehicles, large containers, transport pallets, packaging laminates, in the furniture industry, for example for furniture parts, doors, linings, in electronics applications.

Cooling apparatuses of the invention have, as insulation material, a PU foam of the invention (polyurethane or polyisocyanurate foam).

The invention further provides for the use of the PU foam as insulation material in refrigeration technology, in refrigeration equipment, in the construction sector, automobile sector, shipbuilding sector and/or electronics sector, as insulation boards, as spray foam, as one-component foam.

The subject matter of the invention is described by way of example hereinbelow, without any intention that the invention be restricted to these illustrative embodiments. Where ranges, general formulae or classes of compounds are stated, these are intended to encompass not only the corresponding ranges or groups of compounds explicitly mentioned but also all subranges and subgroups of compounds that can be obtained by removing individual values (ranges) or compounds. Where documents are cited in the context of the present description, the entire content thereof, particularly with regard to the subject matter that forms the context in which the document has been cited, is intended to form part of the disclosure content of the present invention. Unless stated otherwise, percentages are in weight percent. Where average values are given hereinbelow, the values concerned are weight averages, unless otherwise stated. Where parameters that have been determined by measurement are given hereinbelow, the measurements were carried out at a temperature of 25° C. and a pressure of 101 325 Pa, unless otherwise stated.

The examples which follow describe the present invention by way of example, without any intention of restricting the invention, the scope of application of which is apparent from the entirety of the description and the claims, to the embodiments cited in the examples.

### EXAMPLES

The following materials were used as Si-free surfactants (SifS).
SifS No. 1: Diethanolamide based on soybean oil and diethanolamine, prepared as described as amide 2 in example 1b of DE 102011007479 A1.
SifS No. 2: Imidazole based on N-(2-aminoethyl)ethanolamine and coconut fatty acid as described in example 3 of U.S. Pat. No. 2,267,965.
SifS No. 3: Sorbitan monolaurate, commercially available as TEGO SML from Evonik.
SifS No. 4: Novolak-based surfactant as described in DE 3724716 C1 as foam stabilizer A.
SifS No. 5: Ethoxylate of a hydrogenated ketone-aldehyde resin as described in EP 3320012 B1 as OHV-3.

The hydrocarbons (HC) used were the following materials:

### HC-A:

Oxo oil based on hydroformylation products of dodecene as arise as by-products in the production of iso-C₁₃ alcohols, as arises as low boiler fraction, the “light oxo fraction”, commercially available as Oxo oil LS 13 from Evonik.

### HC B:

Tetrabutene, produced as oligomer based on butene and as described in DE102008007081A1, commercially available as Tetrabutene from Evonik.

The polyalkylsiloxane (PAS) used was the following material:
PAS A: Trisiloxane with octyl side chain corresponding to the formula 1, Mₐ D_{b} T_{c} Q_{d}, as defined above with a=2; b=1; c=0; d=0; R¹¹=methyl; R¹²=methyl; R¹³=methyl; R¹⁴=octyl, R¹⁵=methyl; as described in WO 2020/144003 A1 as PAS No. 5.

For the production in accordance with the invention of rigid PU foams, the Si-free surfactants were used in a mixture or combination together with the various hydrocarbons and the polyalkylsiloxane.

This was done using the following mixtures that are summarized in Table 2.

TABLE 2
Description of the SifS/HC mixtures
(overview of SifS/HC combinations)

| | | SifS | | HC | PAS A |
|---|---|---|---|---|---|
| | SifS | Proportion | HC | Proportion | Proportion |
| | Type | by weight | Type | by weight | by weight |
| Mixture 1 | No. 1 | 90 | A | 10 | |
| Mixture 2 | No. 2 | 90 | A | 10 | |
| Mixture 3 | No. 3 | 90 | A | 10 | |
| Mixture 4 | No. 4 | 90 | A | 10 | |
| Mixture 5 | No. 5 | 90 | A | 10 | |
| Mixture 6 | No. 1 | 86 | A | 9 | 5 |
| Mixture 7 | No. 2 | 86 | A | 9 | 5 |
| Mixture 8 | No. 3 | 86 | A | 9 | 5 |
| Mixture 9 | No. 1 | 90 | B | 10 | |
| Mixture 10 | No. 2 | 90 | B | 10 | |
| Mixture 11 | No. 3 | 90 | B | 10 | |
| Mixture 12 | No. 5 | 90 | B | 10 | |

In foaming experiments foams containing one of the aforementioned mixtures of Si-free surfactant, hydrocarbon HC and optionally polyalkylsiloxane PAS were compared in terms of their properties with compositions that instead of the aforementioned mixture contained only the corresponding Si-free surfactant:

SifS No. 1 is compared with mixtures 1, 6 and 9.

SifS No. 2 is compared with mixtures 2, 7 and 10.

SifS No. 3 is compared with mixtures 3, 8 and 11.

SifS No. 4 is compared with mixture 4.

SifS No. 5 is compared with mixtures 5 and 12.

Foams were produced using the following raw materials:
Stepanpol PS 2412: polyester polyol from Stepan
TCPP: tris(2-chloroisopropyl) phosphate from Fyrol (flame retardant)
POLYCAT 5 from Evonik Operations GmbH, amine-based catalyst
Kosmos 75 from Evonik Operations GmbH, catalyst based on potassium octoate
Polycat 5 from Evonik Operations GmbH, amine catalyst
MDI (44V20): Desmodur 44V20L from Covestro, diphenylmethane 4,4′-diisocyanate (MDI) with isomeric and higher-functionality homologues.

### Production of PU Foams:

Foaming was carried out by manual mixing. To this end, all components as per Table 3 except for the polyisocyanate (MDI) were weighed into a beaker and mixed by means of a disc stirrer (diameter 6 cm) at 1000 rpm for 30 s. The beaker was reweighed to determine the amount of blowing agent that had evaporated during the mixing operation and this was replenished. Subsequently, the polyisocyanate (MDI) was added, and the reaction mixture was stirred with the stirrer described at 3000 rpm for 5 s.

In the case of the PIR formulations (polyisocyanurate formulations) used here, for panel applications, for example building insulation, the mixture was introduced immediately into an aluminium mould of dimensions 50 cm×25 cm×7 cm which had been heated to 65° C. The use amount of foam formulation was such that the amount was sufficient for minimum filling of the mould. The foams were demoulded after 10 minutes and then stored at room temperature for 24 hours.

A cut surface in the foam was used to visually assess the degree of internal defects and the pore structure on a scale from 1 to 10, where 10 represents an impeccable foam and 1 a very significantly defective foam.

The thermal conductivity coefficient (A value in mW/m-K) was measured on 2.5 cm-thick discs after one day (1 d) and after 7 days (7 d) with an instrument of the Hesto Lambda Control type, model HLC X206, at an average temperature of 10° C. in accordance with the specifications of standard EN 12667:2001-05.

Table 3 summarizes the foam formulations used.

TABLE 3
(figures in parts by weight)

| Formulation | PIR-1 | PIR-2 |
|---|---|---|
| PS 2412 | 100 | 100 |
| KOSMOS 75 | 3 | 3 |
| Polycat 5 | 0.5 | 0.5 |
| either mixture of SifS, HC and optionally | 3 | 3 |
| PAS, or SifS alone | | |
| TCPP | 8 | 8 |
| Water | 0.5 | 0.5 |
| Isopentane | 4.5 | 10.5 |
| Cyclopentane | 10.4 | 4.5 |
| MDI (44V20) | 200 | 200 |

The results of the foaming experiments with the mixtures of SifS, HC and optionally PAS compared to SifS alone are summarized in Table 4. As described above, panels were produced and the lambda values (in mW/m·K) were measured after 1 day and 7 days, and the internal defects evaluated on a scale from 1-10.

TABLE 4
Results of the foaming experiments

| | | Formulation | Lambda | Lambda | Internal |
|---|---|---|---|---|---|
| Foam | Mixture or SifS | (PIR) | (1 d) | (7 d) | defects |
| Comp. 1 | SifS No. 1 | 1 | 22.2 | 26.3 | 7.5 |
| | (noninventive) | | | | |
| 1 | Mixture 1 | 1 | 20.5 | 23.0 | 8 |
| 2 | Mixture 6 | 1 | 20.1 | 22.7 | 7.5 |
| 3 | Mixture 9 | 1 | 20.2 | 22.6 | 8 |
| Comp. 2 | SifS No. 2 | 1 | 21.6 | 28.6 | 8 |
| | (noninventive) | | | | |
| 4 | Mixture 2 | 1 | 20.2 | 23.0 | 7.5 |
| 5 | Mixture 7 | 1 | 20.3 | 22.8 | 7 |
| 6 | Mixture 10 | 1 | 20.4 | 23.1 | 7 |
| Comp. 3 | SifS No. 3 | 1 | 21.7 | 24.7 | 7.5 |
| | (noninventive) | | | | |
| 7 | Mixture 3 | 1 | 20.3 | 22.8 | 7.5 |
| 8 | Mixture 8 | 1 | 20.6 | 23.2 | 7.5 |
| 9 | Mixture 11 | 1 | 20.3 | 22.9 | 7.5 |
| Comp. 4 | SifS No. 4 | 1 | 21.1 | 23.5 | 7.5 |
| | (noninventive) | | | | |
| 10 | Mixture 4 | 1 | 20.8 | 24.1 | 7.5 |
| Comp. 5 | SifS No. 5 | 1 | 21.3 | 23.7 | 8 |
| 11 | Mixture 5 | 1 | 20.3 | 22.8 | 8 |
| 12 | Mixture 12 | 1 | 20.4 | 22.8 | 8 |
| Comp. 6 | SifS No. 1 | 2 | 21.7 | 25.1 | 7 |
| | (noninventive) | | | | |
| 13 | Mixture 1 | 2 | 21.5 | 24.3 | 7 |
| Comp. 7 | SifS No. 2 | 2 | 24.2 | 27.9 | 8 |
| | (noninventive) | | | | |
| 14 | Mixture 2 | 2 | 20.8 | 25.9 | 7.5 |
| Comp. 8 | SifS No. 3 | 2 | 21.5 | 24.3 | 7 |
| | (noninventive) | | | | |
| 15 | Mixture 3 | 2 | 21.2 | 23.7 | 8 |
| Comp. 9 | SifS No. 5 | 2 | 21.6 | 24.2 | 7.5 |
| | (noninventive) | | | | |
| 16 | Mixture 5 | 2 | 21.2 | 23.6 | 8 |

It is clearly apparent from the experiments that the mixtures according to the invention and consisting of hydrocarbons HC, Si-free surfactant SifS and optionally polyalkylsiloxane PAS lead to improved insulation properties compared to SifS alone.

It should be particularly emphasized here that even a very small addition of HC and optionally PAS leads to measurable improvements.

1-15. (canceled)

16. A composition for producing a polyurethane foam, comprising:
a) at least one polyisocyanate component;
b) a polyol component;
c) optionally, a catalyst that catalyses the formation of a urethane or isocyanurate bond;
d) optionally a blowing agent;
wherein the composition additionally comprises hydrocarbons that have boiling points at a standard pressure of >100° C., and an Si-free (silicon-free) surfactant.

17. The composition of claim 16, wherein the hydrocarbons have 10 to 24 carbon atoms.

18. The composition of claim 17, wherein the hydrocarbons are selected from the group consisting of: decene, dodecene, dodecane, isododecane, tetradecane, tributene, tributane, tetrabutene, tetrabutane, alkylbenzenes having at least 10 carbon atoms and oxo oils.

19. The composition of claim 16, wherein the Si-free surfactant, when in a surfactant-water mixture in which the Si-free surfactant is at a concentration of 0.5% by weight, lowers the static surface tension of the surfactant-water mixture at a temperature of 20° C. to less than 70 mN/m.

20. The composition of claim 19, wherein the Si-free surfactant, at a concentration of 0.5% by weight in water, lowers the static surface tension of the surfactant-water mixture at a temperature of 20° C. to less than 40 mN/m.

21. The composition of claim 16, wherein the Si-free surfactant is, or comprises, a nonionic surfactant.

22. The composition of claim 16, wherein the Si-free surfactant is or comprises a carboxylic acid derivative selected from the group consisting of esters, amides, imides, imidazolines, oxazolines, and polyether compounds.

23. The composition of claim 16, wherein the hydrocarbons are used in combination with Si-free surfactant in a mass ratio of 1:5 to 1:200.

24. The composition of claim 16, further comprising polyalkylsiloxanes.

25. The composition of claim 24, wherein the polyalkylsiloxanes contain fewer than 20 silicon atoms.

26. The composition of claim 24, wherein the polyalkylsiloxanes in relation to the Si-free surfactant are used in a mass ratio of 1:4 to 1:200.

27. The composition of claim 26, wherein the proportion by mass of the total amount of hydrocarbons, Si-free surfactant and optional polyalkylsiloxanes, based on 100 parts by mass of polyol component, is from 0.1 to 10 pphp.

28. The composition of claim 27, wherein the proportion by mass of the total amount of hydrocarbons, Si-free surfactant and optional polyalkylsiloxanes, based on 100 parts by mass of polyol component, is from 1 to 3 pphp.

29. The composition of claim 26, wherein the polyalkylsiloxanes conform to formula 1: 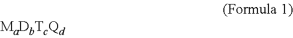
where:
M=R¹¹R¹²R¹³SiO_{1/2}
D R¹⁴R¹⁵SiO_{2/2}
T=R¹⁶SiO_{3/2}
Q=SiO_{4/2}
wherein:
R¹¹, R¹², R¹³, R¹⁴, R¹⁵, R¹⁶=identical or different hydrocarbon radicals having 1 to 12, and the hydrocarbon radicals are optionally substituted by heteroatoms, or H;
and wherein:
a=2 to 6;
b=0 to 8;
c=0 to 4;
d=0 to 2;
with the proviso that a+b+c+d<20.

30. The composition of claim 29, wherein a+b+c+d<11.

31. The composition of claim 29, wherein the hydrocarbons are selected from the group consisting of: decene, dodecene, dodecane, isododecane, tetradecane, tributene, tributane, tetrabutene, tetrabutane, alkylbenzenes having at least 10 carbon atoms and oxo oils.

32. The composition of claim 29, wherein:
R¹⁶ is different from R¹¹, R¹², R¹³, R¹⁴ and R¹⁵,
and/or R¹¹, R¹² and R¹³ are different.

33. A process for producing polyurethane foam by reacting one or more polyol components with one or more polyisocyanate components, using the composition of claim 16.

34. The process of claim 33, wherein the hydrocarbons, Si-free surfactant and optional polyalkylsiloxanes are supplied separately or together to the reaction mixture for production of the polyurethane foam.

35. A polyurethane foam obtainable by the process of claim 33.
